(19) United States
(12) Patent Application Publication
(10) Pub. No.: US 2022/0164744 A1
(43) Pub. Date: May 26, 2022

(54) DEMAND FORECASTING OF SERVICE REQUESTS VOLUME

(71) Applicant: INTERNATIONAL BUSINESS MACHINES CORPORATION, Armonk, NY (US)

(72) Inventors: Bing Zhang, College Station, TX (US); Shubhi Asthana, Santa Clara, CA (US); Pawan Chowdhary, San Jose, CA (US); Aly Megahed, San Jose, CA (US); Rohit Avinash Mujumdar, Atlanta, GA (US); Taiga Nakamura, Sunnyvale, CA (US)

(21) Appl. No.: 16/953,974

(22) Filed: Nov. 20, 2020

(51) Int. Cl. G06Q 10/06; G06Q 30/02; G06Q 10/04; G06Q 30/00; G06N 20/00

(52) U.S. Cl. CPC G06Q 10/06315; G06Q 30/0205; G06Q 10/06395; G06Q 10/06311; G06N 20/00; G06Q 10/06398; G06Q 30/016; G06Q 30/0201; G06Q 10/04

(57) ABSTRACT

A method for predicting service requests volume includes generating a machine learning model predicting a number of service requests in time series data, based upon a plurality of actually received service requests in the time series data. The method recommends service request features for use in predicting the service requests volume. The method receives a determination from an human-in-the-loop indicating whether the generated machine learning model correctly predicts the number of service requests in time series data, based on the plurality of actually received service requests in the time series data and the recommended service request features. The method selectively updates the machine learning model predicting the number of service requests in times series data, based upon the determination from the human-in-the-loop. The method predicts, using the updated machine learning model, a number of service requests in time series data incoming during a future time period.

### BACKGROUND

The present invention generally relates to forecasting, and more particularly to demand forecasting of service requests volume.

Every day, sales support work with customers, trying to close contracts with potential clients. While negotiating and closing contracts, sales support often requests Quote To Cash (Q2C) support and opens a new Service Request (SR) with the sales team. A squad team member works on the SR requests and supports the salesperson. SRs are requests from the sales workforce while they are closing contracts with potential clients. Each SR can be a pre-sale or post-sale kind of service received from different geographies. These SRs are routed to the appropriate squad to handle the relevant issues. Each SR may require specific squad talent, have an urgent due date, require being signed with confidentiality regulations, can be cancelled while being processing, and/or so forth. Due to the complexity of a SR, a unique squad may be assigned to work on the SR.

Therefore, it has been observed that SR volumes vary because of various features. For example, in a Cognitive Squad Insights (CSI) project, SR volumes are varied because of the SR nature, squad type, market, brand/sub-brand associated with the SR, geography, and so forth. To that end, the SR volume can vary by a few hundreds of requests per day.

It is important to predict the volume of SR for short term (next couple of weeks) as well as long term (next few months or quarters). This is beneficial so that: squad team members will be prepared in advance; the need new hires in short term or long term can be ascertained; squad workload allocation can be well planned; and so forth.

An allocation of squad workload for SRs needs to be managed ahead of time, by considering the following: specific SR requirements; SR volumes; squad team member utilization; squad team member capacity; and a hiring process period.

Today, support organizations do not have access to a quality demand forecast and staffing recommendation model. Lack of visibility into the volume of SR tickets leads to unbalanced support team, one support team with access capacity and others with, for example, but not limited to, constraint capacity, lower productivity, higher attrition rate due to lower employee sentiment, higher cost to serve due to idle and limited skilled capacity, and lower win rates due to slow response. Therefore, there is a need for forecasting the volume of SR tickets.

### SUMMARY

According to aspects of the present invention, a computer-implemented method is provided for predicting service requests volume. The method includes generating, by a computing device, a machine learning model predicting a number of service requests in time series data, based upon a plurality of actually received service requests in the time series data. The method further includes recommending, by a recommendation engine, service request features for use in predicting the service requests volume. The method also includes receiving, by the computing device from a user interface, a determination from a human-in-the-loop indicating whether the generated machine learning model correctly predicts the number of service requests in time series data, based on the plurality of actually received service requests in the time series data and the recommended service request features. The method additionally includes selectively updating, by the computing device, the machine learning model predicting the number of service requests in times series data, based upon the determination from the human-in-the-loop indicating that the generated machine learning model correctly predicts the number of service requests in time series data. The method further includes predicting, by the computing device using the updated machine learning model, a number of service requests in time series data incoming during a future time period.

In an embodiment, the method can include forming a human-in-the-loop-based feedback loop configured to receive, through the recommendation engine, suggestions of other features from the human-in-the-loop as new model regressors, suggestions of data aggregation methods, and suggestions referring to certain events from sudden changes in data patterns. In this way, new regressors and data aggregation methods can be suggested to obtain improved obtained SR forecasts.

In an embodiment, the recommendation engine provides further recommendations of other service request features for use in predicting the service requests volume based on the determination from the human-in-the-loop indicating that the generated machine learning model incorrectly predicts the number of service requests in time series data. In this way, improved SR forecasts can be obtained.

In an embodiment, the human-in-the-loop determination is based on a customer trust level and a determination of client satisfaction. In this way, a human's impressions can be factored into the final result.

In an embodiment, the method further includes receiving regressor recommendations by the human-in-the-loop applying a contrastive model to the generated machine learning model to obtain a pertinent score. In this way, the performance of the generated forecasting model can be compared and evaluated. Judgements will be made for the user regarding whether other regressors should be included to rebuild the forecasting model.

According to other aspects of the present invention, a computer program product is provided for predicting service requests volume. The computer program product includes a non-transitory computer readable storage medium having program instructions embodied therewith. The program instructions are executable by a computer to cause the computer to perform a method. The method includes generating, by a computing device, a machine learning model predicting a number of service requests in time series data, based upon a plurality of actually received service requests in the time series data. The method further includes recommending, by a recommendation engine, service request features for use in predicting the service requests volume. The method also includes receiving, by the computing device from a user interface, a determination from a human-in-the-loop indicating whether the generated machine learning model correctly predicts the number of service requests in time series data, based on the plurality of actually received service requests in the time series data and the recommended service request features. The method additionally includes selectively updating, by the computing device, the machine learning model predicting the number of service requests in times series data, based upon the determination from the human-in-the-loop indicating that the generated machine learning model correctly predicts the number of service requests in time series data. The method further includes predicting, by the computing device using the updated machine learning model, a number of service requests in time series data incoming during a future time period.

According to yet other aspects of the present invention, a computer processing system is provided for predicting service requests volume. The computer processing system includes a memory device configured to store program code. The computer processing system further includes a processor device, operatively coupled to the memory device, for running the program code to generate a machine learning model predicting a number of service requests in time series data, based upon a plurality of actually received service requests in the time series data. The processor device further runs the program code to recommend, using a recommendation engine, service request features for use in predicting the service requests volume. The processor device also runs the program code to receive a determination through a user interface from a human-in-the-loop indicating whether the generated machine learning model correctly predicts the number of service requests in time series data, based on the plurality of actually received service requests in the time series data and the recommended service request features. The processor device additionally runs the program code to selectively update the machine learning model predicting the number of service requests in times series data, based upon the determination from the human-in-the-loop indicating that the generated machine learning model correctly predicts the number of service requests in time series data. The processor device further runs the program code to predict, using the updated machine learning model, a number of service requests in time series data incoming during a future time period.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 is a block diagram showing an exemplary computing device, in accordance with an embodiment of the present invention;

FIG. 2 shows an exemplary high-level process flow, in accordance with an embodiment of the present invention;

FIG. 3 is a block diagram showing an exemplary system for demand forecasting of Service Requests (SRs) volume, in accordance with an embodiment of the present invention;

FIGS. 4-6 are flow charts showing an exemplary method for demand forecasting of Service Requests (SRs) volume, in accordance with an embodiment of the present invention;

FIG. 7 is a flow diagram showing an exemplary method for configuring a LSTM, in accordance with an embodiment of the present invention;

FIG. 8 is a block diagram showing an illustrative cloud computing environment having one or more cloud computing nodes with which local computing devices used by cloud consumers communicate, in accordance with an embodiment of the present invention; and

FIG. 9 is a block diagram showing a set of functional abstraction layers provided by a cloud computing environment, in accordance with an embodiment of the present invention.

### DETAILED DESCRIPTION

Embodiments of the present invention are directed to demand forecasting of service requests volume.

In an embodiment, inputs to the present invention can include, for example, but are not limited to, world-wide market data and historical squad level SRs. The historical squad level SRs can include, for example, but are not limited to, a submit date (temporal data), sublevel regressors, and squad details. The sublevel regressors (category data), by the example of CSI project, can include, for example, but are not limited to, geography, brand/sub-brand, Engagement Option (Engopt), and so forth. The squad details can include, for example, but are not limited to, Squad_ID, the number of members in a squad, the average utilization of a squad, the capacity of each squad/squad member, and so forth.

In an embodiment, outputs from the present invention can include, for example, but are not limited to: short-term and long-term forecasting of SR volume; identifiable patterns by geography, brand/sub-brand, Engopt, squad feature, and so forth; and squad workload allocation recommendation and optimization.

Some keywords used herein include, but are not limited to the following and their respective definitions.
SR: Service Request.
Squad: Agile concept-group of self-directed members lead by squad leader.
Brand/Sub-brand: Business division/subdivision, e.g., Global Technology Service (GTS), Global Business Service (GBS), etc.
Engopt: The kind of service provided (e.g., Rough Order of Magnitude (ROM) is Post-sales and BID is Pre-sales).
Geography: Market of squads in country-wise.
Cycle time: Time it takes for SR to go from create to complete state.
Capacity: Maximum number of SRs allocated to a squad/squad member at any given point of time.
Utilization: Number of SRs resolved per time.

In an embodiment of the present invention, it is recognized that in order to manage appropriate squad staffing, one needs to know the volume and type of SR demand This is because volumes are analyzed with respect to various features of SR and also because sometimes at the squad level the data gets sparse along with unidentifiable patterns in the dataset. The various features of SR can be geography, brand, sub-brand, Engopt, squad, and so forth. The various features of SR can be analyzed as individual features or a set of features, e.g., geography-brand.

In an embodiment, a business-related goal is to provide useful historical and future information to the customers.

In an embodiment, a final project related goal is to be able to forecast the volume of SR with the best combination of features.

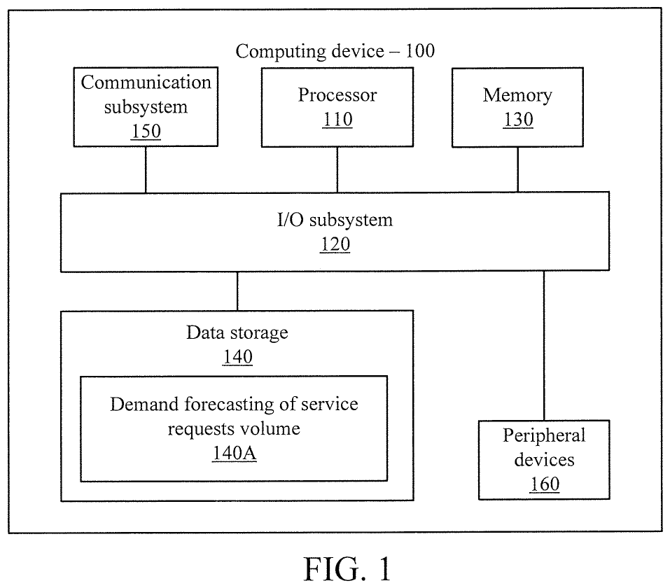

FIG. 1 is a block diagram showing an exemplary computing device 100, in accordance with an embodiment of the present invention. The computing device 100 is configured to perform demand forecasting of service requests volume.

The computing device 100 may be embodied as any type of computation or computer device capable of performing the functions described herein, including, without limitation, a computer, a server, a rack based server, a blade server, a workstation, a desktop computer, a laptop computer, a notebook computer, a tablet computer, a mobile computing device, a wearable computing device, a network appliance, a web appliance, a distributed computing system, a processor- based system, and/or a consumer electronic device. Additionally or alternatively, the computing device 100 may be embodied as a one or more compute sleds, memory sleds, or other racks, sleds, computing chassis, or other components of a physically disaggregated computing device. As shown in FIG. 1, the computing device 100 illustratively includes the processor 110, an input/output subsystem 120, a memory 130, a data storage device 140, and a communication subsystem 150, and/or other components and devices commonly found in a server or similar computing device. Of course, the computing device 100 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 130, or portions thereof, may be incorporated in the processor 110 in some embodiments.

The processor 110 may be embodied as any type of processor capable of performing the functions described herein. The processor 110 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 130 may be embodied as any type of volatile or non-volatile memory or data storage capable of performing the functions described herein. In operation, the memory 130 may store various data and software used during operation of the computing device 100, such as operating systems, applications, programs, libraries, and drivers. The memory 130 is communicatively coupled to the processor 110 via the I/O subsystem 120, which may be embodied as circuitry and/or components to facilitate input/output operations with the processor 110 the memory 130, and other components of the computing device 100. For example, the I/O subsystem 120 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.) and/or other components and subsystems to facilitate the input/output operations. In some embodiments, the I/O subsystem 120 may form a portion of a system-on-a-chip (SOC) and be incorporated, along with the processor 110, the memory 130, and other components of the computing device 100, on a single integrated circuit chip.

The data storage device 140 may be embodied as any type of device or devices configured for short-term or long-term storage of data such as, for example, memory devices and circuits, memory cards, hard disk drives, solid state drives, or other data storage devices. The data storage device 140 can store program code for demand forecasting of service requests volume. The communication subsystem 150 of the computing device 100 may be embodied as any network interface controller or other communication circuit, device, or collection thereof, capable of enabling communications between the computing device 100 and other remote devices over a network. The communication subsystem 150 may be configured to use any one or more communication technology (e.g., wired or wireless communications) and associated protocols (e.g., Ethernet, InfiniBand®, Bluetooth®, Wi-Fi®, WiMAX, etc.) to affect such communication.

As shown, the computing device 100 may also include one or more peripheral devices 160. The peripheral devices 160 may include any number of additional input/output devices, interface devices, and/or other peripheral devices. For example, in some embodiments, the peripheral devices 160 may include a display, touch screen, graphics circuitry, keyboard, mouse, speaker system, microphone, network interface, and/or other input/output devices, interface devices, and/or peripheral devices.

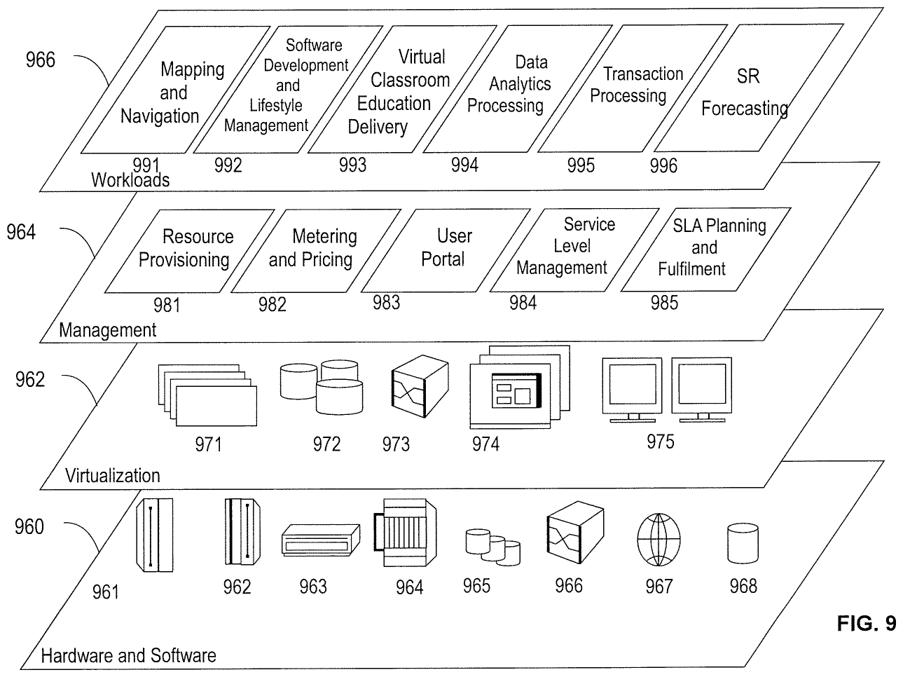

Of course, the computing device 100 may also include other elements (not shown), as readily contemplated by one of skill in the art, as well as omit certain elements. For example, various other input devices and/or output devices can be included in computing device 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. Further, in another embodiment, a cloud configuration can be used (e.g., see FIGS. 9-10). These and other variations of the processing system 100 are readily contemplated by one of ordinary skill in the art given the teachings of the present invention provided herein.

As employed herein, the term “hardware processor subsystem” or “hardware processor” can refer to a processor, memory (including RAM, cache(s), and so forth), software (including memory management software) or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAs, and/or PLAs.

These and other variations of a hardware processor subsystem are also contemplated in accordance with embodiments of the present invention

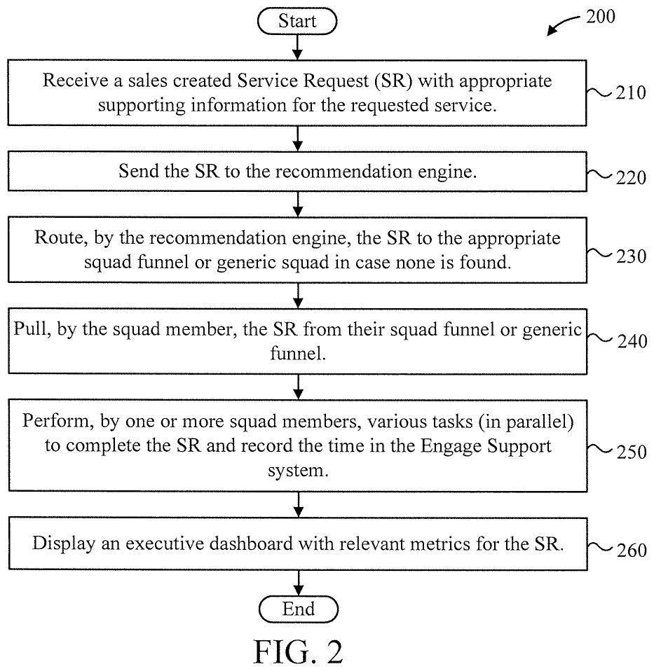

FIG. 2 shows an exemplary high-level process flow 200, in accordance with an embodiment of the present invention.

At block 210, receive a sale created Service Request (SR) with appropriate supporting information for the requested service.

At block 220, send the SR to the routing rules engine.

At block 230, route, by the routing rules engine, the SR to the appropriate squad funnel or generic squad in case none is found.

At block 240, pull, by the squad member, the SR from their squad funnel or generic funnel

At block 250, perform, by one or more squad members, various tasks (in parallel) to complete the SR and record the time in the Engage Support system.

At block 260, display an executive dashboard with relevant metrics for the SR.

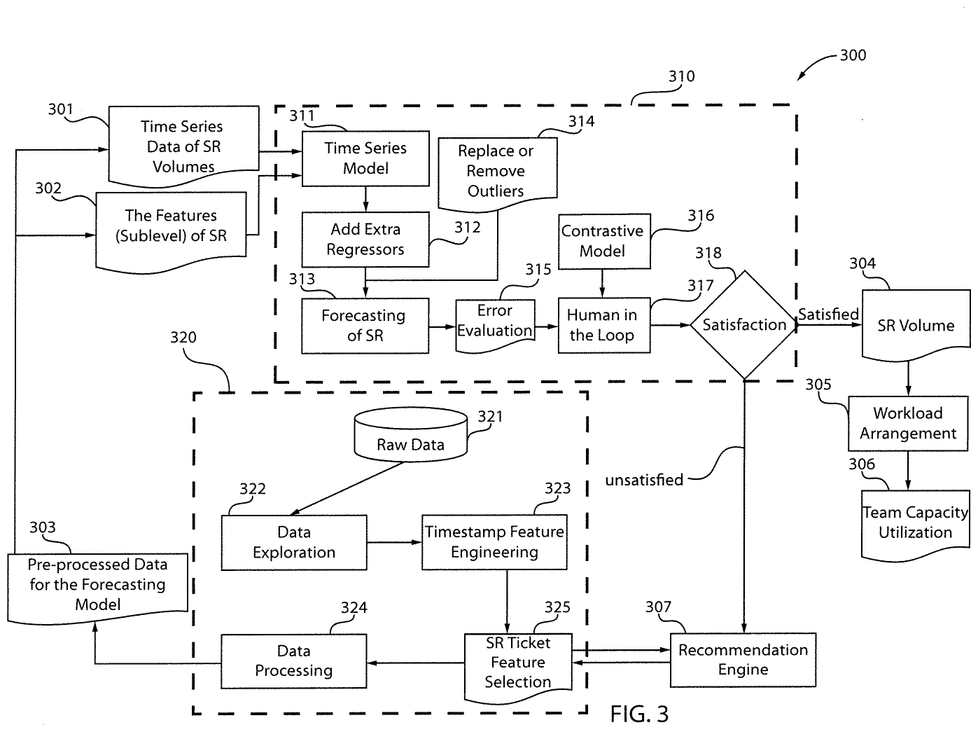

FIG. 3 is a block diagram showing an exemplary system 300 for demand forecasting of Service Requests (SRs) volume, in accordance with an embodiment of the present invention.

Inputs/outputs to the system include time series data of SR volumes 301, features (sub-level) of SR 302, outlier replacement and/or removal 314, error evaluation 315, SR volume 304, a pre-processed data for the forecasting model 303, SR ticket feature selection 325, and a team capacity utilization 306.

A forecasting block 310, used to forecast the SR volume 304, includes a time series model 311, an add extra regressors block 312, a forecasting of SR block 313, error evaluation 315, outlier replacement and/or removal 315, a contrastive model 316, a satisfaction determiner 318, and a human in the loop 316.

A deep dive block 320, used for data pre-processing, includes raw data database 321, a data exploration block 322, a time stamp feature engineering block 323, a data processing block 324, and SR ticket feature selection 325.

The system 300 further includes a workload arrangement block 305 and a recommendation engine 307.

According to the signs in FIG. 3, the sequence of reading this Figure block-wise is 320-310-304-305-306, 307 is embedded in both 310 and 320.

In block 320, a deep dive is made into the raw time-series data of the SR data. General data exploration and cleaning are performed through data normalization, anomaly detection, and error data delete.

Next, the timestamp feature engineering block 323 is processed which aims to help catch the time feature to organize and combine the data into daily, weekly, monthly, or even quarterly basis to make forecasts. Also, the timestamp feature engineering block 323 helps split the data into training and testing datasets by following the data trend. For example, the trend, seasonality, holidays influence time features. After that, a decision is made for a specific time feature, for example, weekly level data following a 13-week trend.

Squad feature selection provides suggestions to choose which features, e.g., levels or sublevels, to be used as model regressors. These features are tested/confirmed by the “recommendation engine” 307 to ensure that they make sense to customers. For example, the features are confirmed to ensure that do not violate any pre-determined rules, for example, about mixing typically unmixable features and so forth. Then the raw data are processed to be used in the forecasting model.

In block 310, the time-series forecasting model utilizes the pre-processed data. Extra regressors are added that are confirmed by the “recommendation engine”, and data outliers are removed or replaced.

A forecast is then made by block 313. The model performance is validated by calculating and comparing the prediction error. The “human in the loop” helps judge whether the validation results are satisfied to customers or not by a contrastive model.

If it is satisfied, then the next step is performed to use the forecasted SR volume to help arrange workload to maximize the team capacity utilization.

If it is not satisfied, it is request to reprocess the data, the “recommendation engine” is where the human will choose extra or new feature combinations as model regressors to generate the forecasting model again.

In an embodiment, a processing device (e.g., a CPU, GPU, etc.) and a memory device with special purpose programming code are configured as a hybrid-hardware-based recommendation engine that performs the specialized function of forecast-based feature/regressor recommending, in further detail recommending feature regressors, sub-regressors and/or other parameters in a machine-based processing loop having a human interjected therein. The human and machine perform various aspects of the processing loop to cooperatively provide an optimized forecast. In an embodiment, a forecasted Service Request volume is optimized for workload distribution and/or other operation parameters pertaining to one or more work squads.

To that end, the recommendation engine includes special purpose code stored in the memory device. The special purpose code, when executed by the processor, performs the recommending functions described herein.

In an embodiment, a recommendation engine can include and/or otherwise be implemented by a hardware processor as described herein. In an embodiment, the recommendation engine is implemented by an Application Specific Integrated Circuit (ASIC) optimized to interact with a human-in-the-loop in order to make feature recommendations in an accurate and expedient manner.

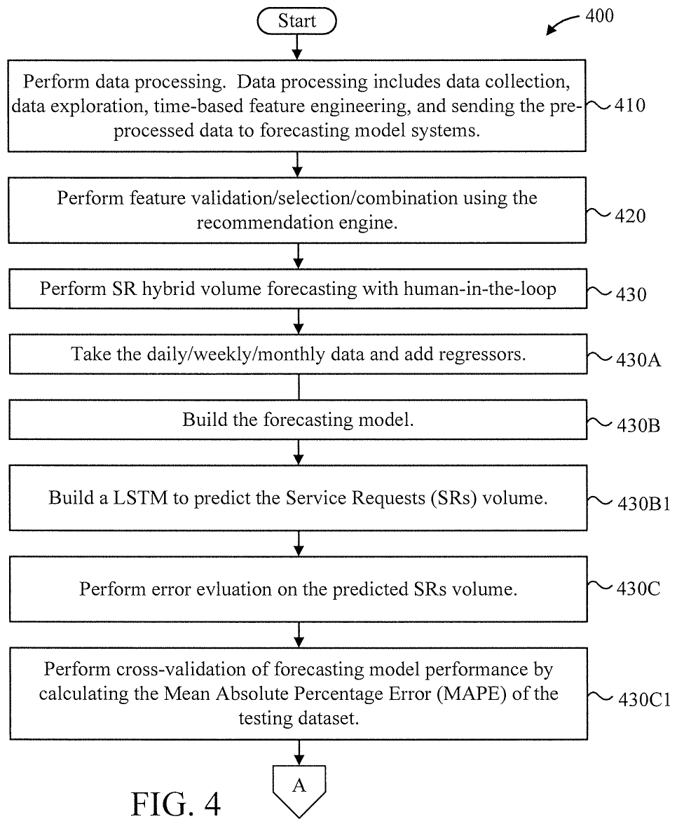

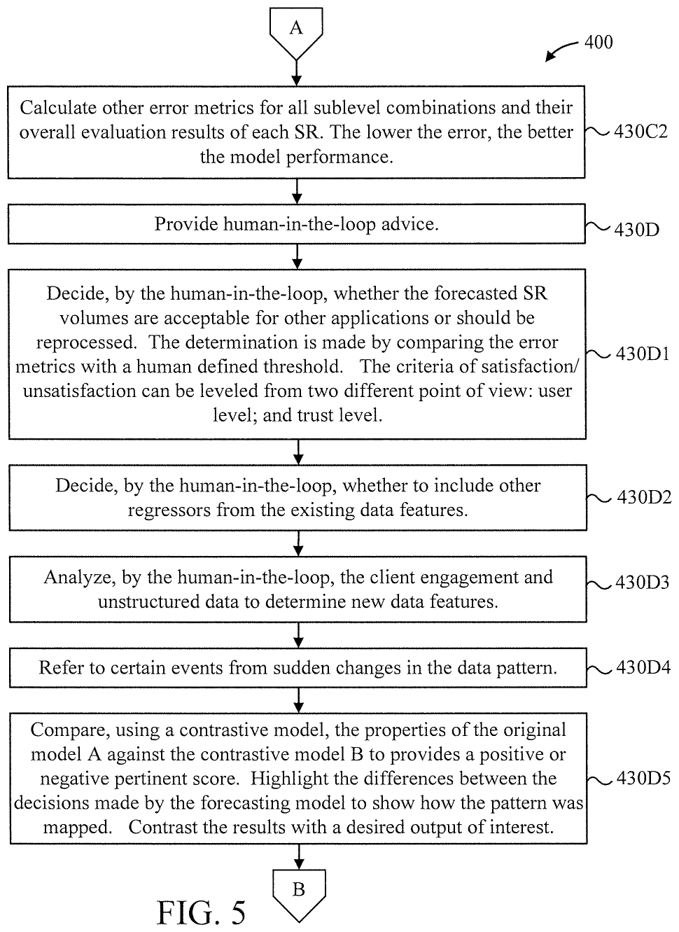

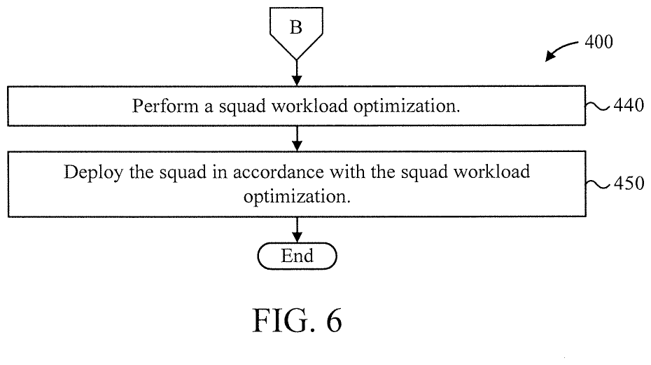

FIGS. 4-6 are flow charts showing an exemplary method 400 for demand forecasting of Service Requests (SRs) volume, in accordance with an embodiment of the present invention.

At block 410, perform data processing. Data processing includes data collection, data exploration, and time-based feature engineering .

Regarding data collection, historical data will be pulled with a processor from data lakes, clouds and other services to create a large structure database 321.

Regarding data exploration, the collected data will be cleaned. Cleaning can involve the collected data being transformed into usable information for our purpose, e.g., SR features. Cleaning can involve outlier removal 315: the raw data will be checked for errors, and any bad data will be removed. The collected data will be normalized.

Regarding time-based feature engineering 322, the trend of data is removed to help analyze the timestamp feature. Lag timestamp features can be extracted from the timestamp such as, for example, but not limited to, the “time interval” and a “holiday” feature.

The SR ticket features 302 will be selected and tested to be included as regressors 312 in the forecasting model 313.

At block 420, perform feature validation/selection/combination using the recommendation engine.

Since the SR ticket is varied to team type, market, business division, etc., there can exist millions of SR feature combinations. It is important to decide which are the valid features for making forecast and how these features should be combined. Block 420 explores and tests valid features (sublevels) or feature combinations through pre-processing the data from the data sparsity/outlier point of view to decide the best way of combining the data. As examples, the following can be used: combining all Europe countries as one market level; using business subdivisions instead of the business division as a feature in the forecasting model; and combining several business subdivisions together to reduce data sparsity for better forecasting.

When the human-in-the-loop is unsatisfied with block 430's forecasting results and requests to reprocess the data, the recommendation engine is where the human will choose extra or new feature combinations as model regressors. Without this block, the human-in-the-loop is not able to make useful suggestions. On the other hand, the sublevel combination that is suggested by having the lowest model error may be invalid. For example, combining pre-sale and post-sale does not make sense for humans, even though this results in better Mean Absolute Percentage Error (MAPE) of the testing dataset. That is why the human-in-the-loop is important. Also, the human-in-the-loop contrasts actual output with desired results using a contrastive model, and tweaks changes in the features of data preprocessed.

At block 430, perform SR hybrid volume forecasting with human-in-the-loop. Block 430 can involve forecasting the SR volume for different time intervals (daily, weekly, monthly) by the pre-processed data, and performing a satisfaction evaluation of the forecast being done.

In an embodiment, block 430 can involve one or more of blocks 430A and 430B.

At block 430A, take the daily/weekly/monthly data and add regressors.

At block 430B, build the forecasting model to make future prediction of Service Requests (SRs).

430B1 pertains to one example of building the forecasting model using an LSTM. Thus, block 430B1 represents one approach to forecast model building, noting that other approaches to forecast model building can also be used, while maintaining the spirit of the present invention.

At block 430B1, build a LSTM model. There, LSTM is one example of a model for predicting the Service Requests (SRs) volume.

At block 430C, perform error evaluation on the predicted SRs volume.

In an embodiment, block 430C can involve one of more of blocks 430C1 and 430C2.

At block 430C1, perform cross-validation of forecasting model performance by calculating the Mean Absolute Percentage Error (MAPE) of the testing dataset as follows:

$$MAPE = \frac{1}{n} {\sum }_{j = 1}^{n} \vert \frac{{y}_{i} - {\hat{y}}_{j}}{{y}_{i}} \vert .$$

At block 430C2, calculate other error metrics for all sublevel combinations and their overall evaluation results of each SR. The lower the error, the better the model performance.

At block 430D, provide a human-in-the-loop determination. To that end, a determination of whether the generated machine learning model correctly predicts the number of service requests in time series is made by the human-in-the-loop based on customer trust level (e.g., 1 to 10, etc.), a (binary) determination of customer satisfaction, an error metric, a level of data sparsity, an outlier amount, and/or so forth. The human-in-the-loop serves as a way to assuredly determine a human-based satisfaction of the forecasted SR volumes. The use of a human-in-the-loop here over a machine provides the following advantages over straight-machine based approaches: suggesting to include other features as new model regressors, which will be linked to the “recommendation engine”, where the human can select appropriate features or feature combinations; referring to certain events from sudden changes in a data pattern and suggesting new data aggregation methods; and making judgements and decisions from expertise. For example, combining pre-sale and post-sale does not make sense for a human, even though this results in better prediction accuracy.

In an embodiment, block 430D can include one or more of blocks 430D1 through 430D5.

At block 430D1, decide, by the human-in-the-loop, whether the forecasted SR volumes are acceptable for other applications or should be reprocessed. The determination is made by comparing the calculated error metrics with a human defined threshold. The criteria of satisfaction/unsatisfaction can be leveled from two different point of view: user level; and trust level.

At block 430D2, decide, by the human-in-the-loop, whether to include other regressors from the existing data features.

At block 430D3, analyze, by the human-in-the-loop, the client engagement and unstructured data to determine new data features.

At block 430D4, refer to certain events from sudden changes in the data pattern. For example, the sudden loss of a customer is usually only known by the human.

At block 430D5, compare, using a contrastive model, the properties of the original model A against the contrastive model B, to provide a positive or negative pertinent score. Highlight the differences between the decisions made by the forecasting model to show how the pattern was mapped. Contrast the results with a desired output of interest.

At block 440, perform a workload optimization. In an embodiment, an objective is to use the minimum number of team members to reach target capacity utilization. In that case, we will include the following parameters and variables in the constraints (1) the forecasted volume of SR ticket; (2) the number of teams; (3) the number of team members in each team; (4) the maximum amount of team members in each team, which depends on the team features, its management and hiring process, etc.; and (5) the average efficiency of each team member.

At block 450, deploy the squad in accordance with the squad workload optimization.

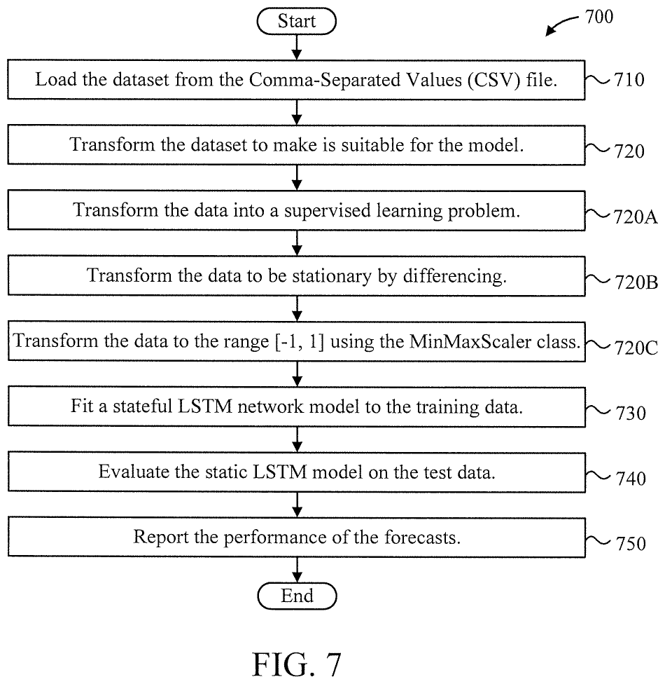

FIG. 7 is a flow diagram showing an exemplary method 700 for configuring a LSTM, in accordance with an embodiment of the present invention.

At block 710, load the dataset from the Comma-Separated Values (CSV) file.

At block 720, transform the dataset to make is suitable for the model. That is, consider the timestamp level, the useful squad features, level/sublevel regressors, etc. in the model.

In an embodiment, block 720 can include one or more of blocks 720A through 720C.

At block 720A, transform the data into a supervised learning problem.

At block 720B, transform the data to be stationary by differencing.

At block 720C, transform the data to the range [−1, 1] using the MinMaxScaler class. Many machine learning algorithms perform better when numerical input variables are scaled to a standard range.

At block 730, fit a stateful LSTM network model to the training data.

At block 740, evaluate the static LSTM model on the test data.

At block 750, report the performance of the forecasts.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

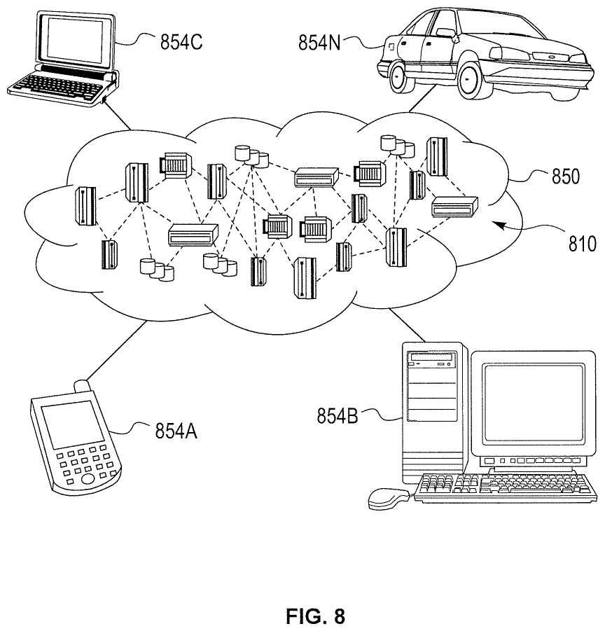

Referring now to FIG. 8, illustrative cloud computing environment 850 is depicted. As shown, cloud computing environment 850 includes one or more cloud computing nodes 810 with which local computing devices used by cloud consumers, such as, for example, personal digital assistant (PDA) or cellular telephone 854A, desktop computer 854B, laptop computer 854C, and/or automobile computer system 854N may communicate. Nodes 810 may communicate with one another. They may be grouped (not shown) physically or virtually, in one or more networks, such as Private, Community, Public, or Hybrid clouds as described hereinabove, or a combination thereof. This allows cloud computing environment 850 to offer infrastructure, platforms and/or software as services for which a cloud consumer does not need to maintain resources on a local computing device. It is understood that the types of computing devices 854A-N shown in FIG. 8 are intended to be illustrative only and that computing nodes 810 and cloud computing environment 950 can communicate with any type of computerized device over any type of network and/or network addressable connection (e.g., using a web browser).

Referring now to FIG. 9, a set of functional abstraction layers provided by cloud computing environment 850 (FIG. 8) is shown. It should be understood in advance that the components, layers, and functions shown in FIG. 9 are intended to be illustrative only and embodiments of the invention are not limited thereto. As depicted, the following layers and corresponding functions are provided:

Hardware and software layer 960 include hardware and software components. Examples of hardware components include: mainframes 961; RISC (Reduced Instruction Set Computer) architecture-based servers 962; servers 963; blade servers 964; storage devices 965; and networks and networking components 966. In some embodiments, software components include network application server software 967 and database software 968.

Virtualization layer 970 provides an abstraction layer from which the following examples of virtual entities may be provided: virtual servers 971; virtual storage 972; virtual networks 973, including virtual private networks; virtual applications and operating systems 974; and virtual clients 975.

In one example, management layer 980 may provide the functions described below. Resource provisioning 981 provides dynamic procurement of computing resources and other resources that are utilized to perform tasks within the cloud computing environment. Metering and Pricing 982 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 983 provides access to the cloud computing environment for consumers and system administrators. Service level management 984 provides cloud computing resource allocation and management such that required service levels are met. Service Level Agreement (SLA) planning and fulfillment 1085 provide pre-arrangement for, and procurement of, cloud computing resources for which a future requirement is anticipated in accordance with an SLA.

Workloads layer 990 provides examples of functionality for which the cloud computing environment may be utilized. Examples of workloads and functions which may be provided from this layer include: mapping and navigation 991; software development and lifecycle management 992; virtual classroom education delivery 993; data analytics processing 994; transaction processing 995; and SR forecasting 996.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as SMALLTALK, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A computer-implemented method for predicting service requests volume, comprising:
generating, by a computing device, a machine learning model predicting a number of service requests in time series data, based upon a plurality of actually received service requests in the time series data;
recommending, by a recommendation engine, service request features for use in predicting the service requests volume and forming a human-in-the-loop-based feedback loop configured to receive, through the recommendation engine, one or more suggestions;
receiving, by the computing device from a user interface, a determination from the human-in-the-loop indicating whether the generated machine learning model correctly predicts the number of service requests in time series data, based on the plurality of actually received service requests in the time series data and the recommended service request features;
selectively updating, by the computing device, the machine learning model predicting the number of service requests in times series data, based upon the determination from the human-in-the-loop indicating that the generated machine learning model correctly predicts the number of service requests in time series data; and
predicting, by the computing device using the updated machine learning model, a number of service requests in time series data incoming during a future time period.

2. The computer-implemented method of claim 1, wherein the service requests are associated with a sales team.

3. The computer-implemented method of claim 1, of other features frond the human-in-the-loop as new model regressors, suggestions of data aggregation methods, and suggestions referring to certain events from sudden changes in data patterns.

4. The computer-implemented method of claim 1, wherein the recommendation engine provides further recommendations of other service request features for use in predicting the service requests volume based on the determination from the human-in-the-loop indicating that the generated machine learning model incorrectly predicts the number of service requests in time series data.

5. The computer-implemented method of claim 1, wherein the recommendation engine suggests the service request features based on one or more objects selected from the group consisting of an error metric, a data sparsity amount, and an outlier level implicated.

6. The computer-implemented method of claim 1, further comprising predicting, by the computing device using the updated machine learning model, at least one of a squad workload allocation recommendation and a squad workload allocation optimization.

7. The computer-implemented method of claim 1, wherein a squad workload allocation optimization is based on a number of service requests received over a fixed period, a squad efficiency, a number of squad members, an average squad utilization, and a maximum squad member threshold.

8. The computer-implemented method of claim 1, wherein a squad workload allocation optimization is formulated as an optimization problem having an objective of using a minimum number of squad members of a squad to reach a target capacity utilization of the squad.

9. The computer-implemented method of claim 1, wherein a determination of whether the generated machine learning model correctly predicts the number of service requests in time series is made by the human-in-the-loop based on one or more objects selected from the group consisting of an error metric, a customer trust level, a determination of customer satisfaction, a level of data sparsity, and an outlier amount.

10. The computer-implemented method of claim 9, wherein an error metric is calculated by performing cross-validation of model performance by calculating a mean absolute percentage error of a testing dataset.

11. The computer-implemented method of claim 9, wherein the number of service requests in time series is predicted based on a combination of features providing a lowest value for the error metric from a plurality of feature and sub-feature combinations.

12. The computer-implemented method of claim 9, wherein the error metric is compared to a human-in-the-loop defined threshold.

13. The computer-implemented method of claim 1, wherein said generating step generates the machine learning model predicting a number of service requests in time series data using one or more regressors.

14. The computer-implemented method of claim 1, further comprising preprocessing the plurality of service requests to remove data outliers therefrom.

15. The computer-implemented method of claim 1, further comprising pre-processing, by the computing device using time-based feature engineering, the plurality of actually received service requests in the time series data to remove a data trend therefrom for timestamp feature analysis.

16. The computer-implemented method of claim 1, wherein the human-in-the-loop determination is based on a customer trust level and a determination of client satisfaction.

17. The computer-implemented method of claim 1, wherein the updated machine learning model comprise a trend modeling component, a Fourier-series based seasonality component, and a holiday component.

18. The computer-implemented method of claim 1, further comprising receiving regressor recommendations by the human-in-the-loop applying a contrastive model to the generated machine learning model to obtain a pertinent score.

19. A computer program product for predicting service requests volume, the computer program product comprising a non-transitory computer readable storage medium having program instructions embodied therewith, the program instructions executable by a computer to cause the computer to perform a method comprising:
generating, by a computing device, a machine learning model predicting a number of service requests in time series data, based upon a plurality of actually received service requests in the time series data;
recommending, by a recommendation engine, service request features for use in predicting the service requests volume and forming a human-in-the-loop-based feedback loop configured to receive, through the recommendation engine, one or more suggestions;
receiving, by the computing device from a user interface, a determination from the human-in-the-loop indicating whether the generated machine learning model correctly predicts the number of service requests in time series data, based on the plurality of actually received service requests in the time series data and the recommended service request features;
selectively updating, by the computing device, the machine learning model predicting the number of service requests in times series data, based upon the determination from the human-in-the-loop indicating that the generated machine learning model correctly predicts the number of service requests in time series data; and
predicting, by the computing device using the updated machine learning model, a number of service requests in time series data incoming during a future time period.

20. A computer processing system for predicting service requests volume, comprising:
a memory device configured to store program code; and
a processor device, operatively coupled to the memory device, for running the program code to
generate a machine learning model predicting a number of service requests in time series data, based upon a plurality of actually received service requests in the time series data;
recommend, using a recommendation engine, service request features for use in predicting the service requests volume and form a human-in-the-loop-based feedback loop configured to receive, through the recommendation engine, one or more suggestions;
receive a determination through a user interface from the human-in-the-loop indicating whether the generated machine learning model correctly predicts the number of service requests in time series data, based on the plurality of actually received service requests in the time series data and the recommended service request features;
selectively update the machine learning model predicting the number of service requests in times series data, based upon the determination from the human-in-the-loop indicating that the generated machine learning model correctly predicts the number of service requests in time series data; and
predict, using the updated machine learning model, a number of service requests in time series data incoming during a future time period.
